(19) United States
(12) Patent Application Publication
(10) Pub. No.: US 2005/0263656 A1
(43) Pub. Date: Dec. 1, 2005

(54) Mounting device for a microphone

(75) Inventor: Chin-Chun Chen, Taipei City (TW)

Correspondence Address: BRINKS HOFER GILSON & LIONE, P.O. BOX 10395, CHICAGO, IL, 60610, US

(73) Assignee: Yoga Electronics Co., Ltd.

(21) Appl. No.: 10/929,612

(22) Filed: Aug. 30, 2004

(30) Foreign Application Priority Data
May 28, 2004 (TW) 093208430

(51) Int. Cl. F16B 1/00

(52) U.S. Cl. 248/229.14

(57) ABSTRACT

A mounting device includes a holder adapted to hold a microphone and having a rod, a seat sleeved fixedly on the rod and having a sleeve body, a locking unit disposed movably around the rod, and a clamping unit adapted to be disposed around a lug of a drum and attached to the seat. The sleeve body includes a plurality of axially extending split parts formed around the rod, and an external screw thread formed on outer surfaces of the split parts. The locking unit includes a tubular member which can be sleeved around the split parts and which has an internal screw thread engageable with the external screw thread to tighten the split parts against the rod. The sleeve body is movable along the rod, and is lockable against movement upon engagement with the tubular member.

### CROSS-REFERENCE TO RELATED APPLICATION

This application claims priority of Taiwanese Application No. 093208430, filed on May 28, 2004.

### BACKGROUND OF THE INVENTION

1. Field of the Invention

The invention relates to a mounting device, more particularly to a mounting device for clamping a microphone on a drum.

2. Description of the Related Art

When a band of drummers perform, microphones are usually mounted on stands at a height similar to the drums so as to capture the sounds and amplify them to be heard by the audience or to facilitate recording of the music. The stands are placed at fixed points and at significant distances from the drums so as not to get in the way of the drummers. However, this results in the limited capturing of the sounds by the microphones. Furthermore, these fixed-point-mounted microphones are not suitable for use when the drummers, with the drums strapped on their bodies, have to move from one point to another.

### SUMMARY OF THE INVENTION

Therefore, the object of the present invention is to provide a mounting device that may be installed on a lug of a drum so as to enable mounting of a microphone on top of the musical instrument in order to capture effectively the sound produced from the musical instrument.

According to this invention, a mounting device is provided for clamping a microphone on a musical instrument having at least one lug. The mounting device comprises a holder, a seat, a locking unit, and a clamping unit. The holder is adapted to hold the microphone, and includes a rod and a microphone support mounted on one end of the rod. The seat is sleeved fixedly on the rod proximate to the other end of the rod, and includes a sleeve body. The sleeve body includes a plurality of axially extending split parts formed around the rod, and an external screw thread formed on outer surfaces of the split parts. The locking unit is movably disposed around the rod, and includes a tubular member which can be sleeved around the split parts and which has an internal screw thread engageable with the external screw thread to tighten the split parts against the rod. The sleeve body is movable along the rod, and is lockable against movement upon engagement with the tubular member. The clamping unit is adapted to be disposed around the lug of the drum, and is attached to the seat.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a drum incorporating the preferred embodiment of a mounting device of the present invention with a microphone mounted on the mounting device;

FIG. 2 is a partly exploded perspective view of the preferred embodiment;

FIG. 3 is a fragmentary sectional view of the preferred embodiment, illustrating connections among a locking unit, a C-shaped friction ring, and a sleeve body of a clamping unit;

FIG. 4 is a fragmentary partly sectional schematic top view of the preferred embodiment, illustrating how a second clamp member and a shock-absorbing member cooperate to clamp a lug of the drum; and

FIG. 5 is a view similar to FIG. 4, but illustrating how the clamping unit is loosened from the lug of the drum.

### DETAILED DESCRIPTION OF THE PREFERRED EMBODIMENT

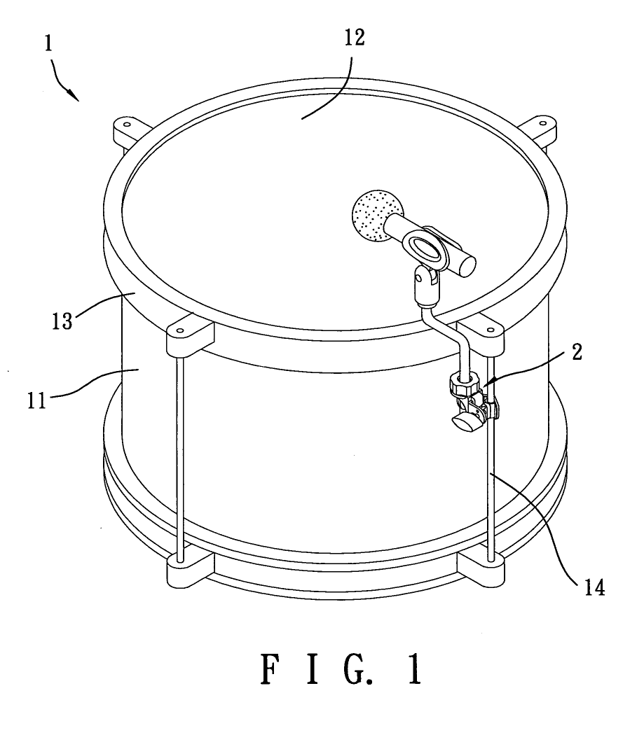

Referring to FIG. 1, the preferred embodiment of a mounting device 2 according to the present invention is adapted to be installed on a musical instrument, such as a drum 1, which has a body 11, a membrane 12 covering at least one end of the body 11, a peripheral edge 13 for positioning the membrane 12 on the body 11, and a plurality of lugs 14 disposed around the body 11 to fix the peripheral edge 13 to the body 11. The mounting device 2 can be detachably mounted on one of the lugs 14, and is adapted to clamp a microphone 3 thereto so that the microphone 3 is mounted on top of the drum 1.

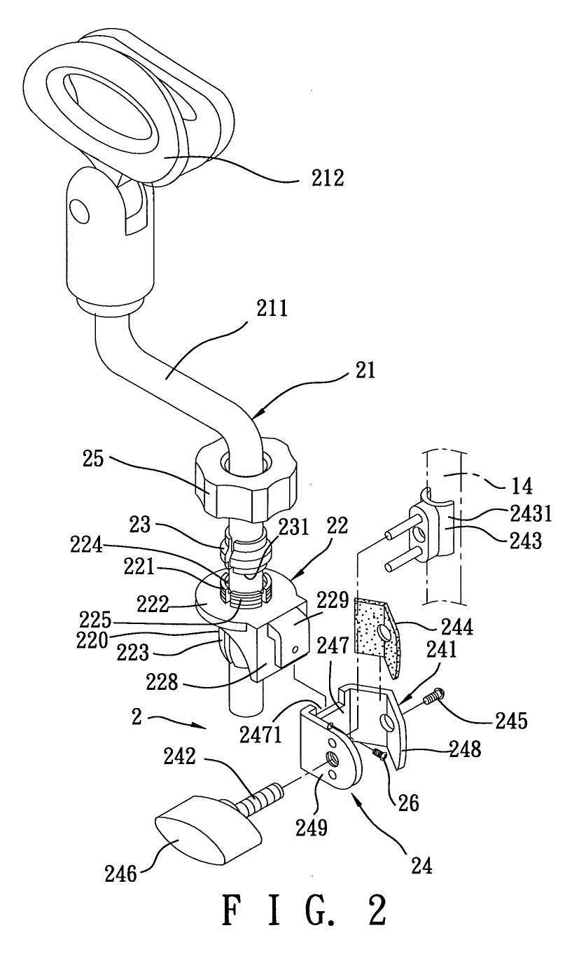

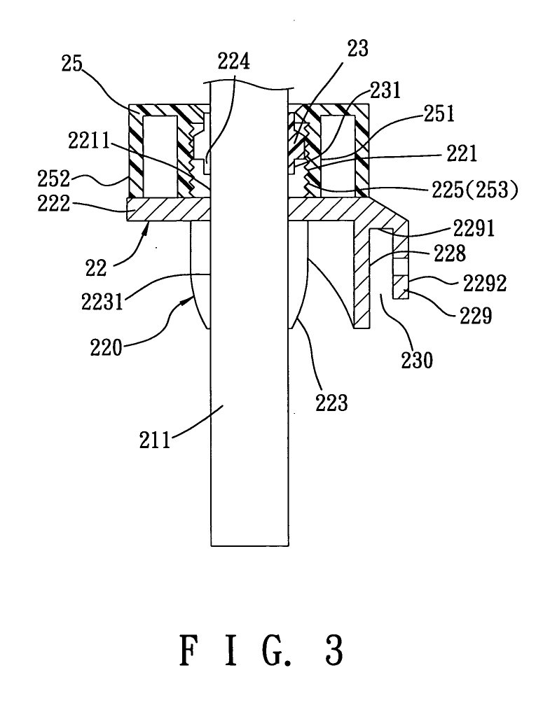

Referring to FIGS. 2 and 3, the mounting device 2 of the present invention is shown to comprise a holder 21, a seat 22, a C-shaped friction ring 23, a locking unit 25, a clamping unit 24, and a first screw 26.

The holder 21 is adapted to hold the microphone 3, and includes a supporting rod 211, and a microphone support 212 engaged threadedly to a top end of the rod 211. The rod 211 has an offset configuration.

The seat 22 is sleeved fixedly on the rod 211 proximate to a bottom end of the rod 211, and includes a sleeve body 220 which is sleeved movably around the rod 211, an annular flange 222 integral with and extending around the sleeve body 220, an attachment plate 228 projecting axially and integrally from an edge of the flange 222, and a substantially L-shaped tab 229. The L-shaped tab 229 has a radial portion 2291 connected to the attachment plate 228, and an axial portion 2292 projecting from the radial portion 2291 to define a receiving space 230 with the attachment plate 228. The sleeve body 220 includes a plurality of axially extending top and bottom split parts 221, 223 formed around the rod 211. The top and bottom split parts 221, 223 have inner surfaces 2211, 2231 abutting against the rod 211. An external screw thread 225 is formed on outer surfaces of the top split parts 221. The inner surfaces 2211 of the top split parts 221 are recessed at ends of the top split parts 221 to form an annular space 224 around the rod 211.

The C-shaped friction ring 23 is sleeved around the rod 211 and located above the seat 22, and has an end 231 extending into the annular space 224.

The locking unit 25 is disposed movably around the rod 211, and includes a tubular member 251 and a hollow knob body 252. The tubular member 251 can be sleeved around the top split parts 221, and has an internal screw thread 253 engageable with the external screw thread 225 so as to tighten the top split parts 221 against the rod 211. The hollow knob body 252 extends around and is integral with the tubular member 251. The sleeve body 220 is movable along the rod 211, and is lockable against movement upon engagement with the locking unit 25.

The clamping unit 24 is connected to the seat 22, and includes a substantially U-shaped first clamp member 241, a threaded shaft 242, a second clamp member 243, a shock-absorbing member 244, a second screw 245, and a rotatable knob 246. The first clamp member 241 is adapted to be disposed around one of the lugs 14 of the drum 1, and has a planar first sidewall 249, a curved second sidewall 248 opposite to the first sidewall 249, and an intermediate wall 247 interconnecting the first and second sidewalls 249, 248 and having a notched edge portion 2471.

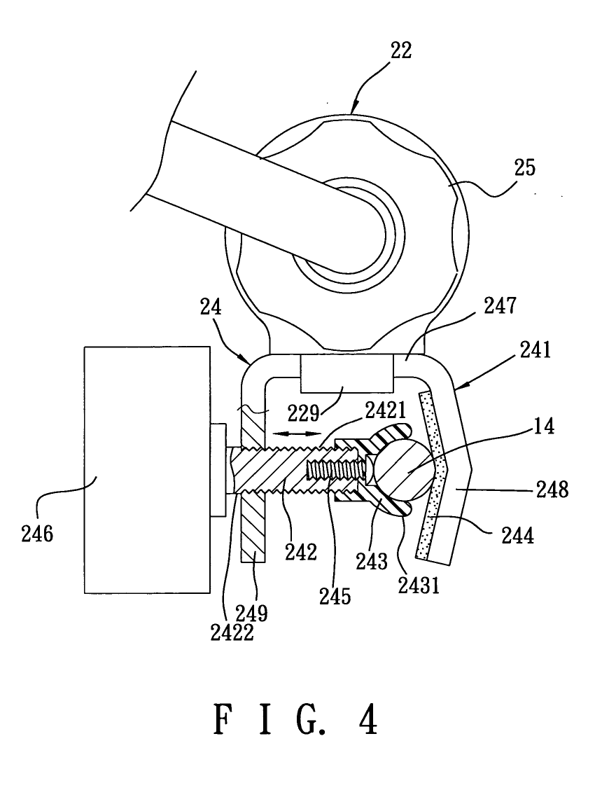

The threaded shaft 242 has a first end portion 2421 (see FIG. 4) extending threadedly through the first sidewall 249 and into the first clamp member 241, and a second end portion 2422 (see FIG. 4) opposite to the first end portion 2421 and located outwardly of the first clamp member 241. The shaft 242 extends in a direction transverse to a direction of the rod 211.

The second clamp member 243 is connected to the first end portion 2421 of the shaft 242 within the first clamp member 241, and has a curved surface 2431 contoured to correspond to an outer surface of the lug 14 of the drum 1. The curved surface 2431 confronts the second sidewall 248 of the first clamp member 241.

The second screw 245 extends through the second clamp member 243, and engages threadedly the first end portion 2421 of the shaft 242 so as to connect fixedly the second clamp member 243 to the shaft 242.

The shock-absorbing member 244 is adhered fixedly to an inner surface of the second sidewall 248, and confronts the second clamp member 243. In this embodiment, the shock-absorbing member 244 is made of rubber, and has a configuration similar to that of the second sidewall 248.

The rotatable knob 246 is connected fixedly to the second end portion 2422 of the shaft 242 so as to enable user-manipulated rotation of the shaft 242. When the shaft 242 is rotated, the second clamp member 243 is movable toward the shock-absorbing member 244. The second clamp member 243 and the shock-absorbing member 244 cooperate with each other to clamp the lug 14 of the drum 1 therebetween.

The first screw 26 fastens the intermediate wall 247 of the first clamp member 241 to the L-shaped tab 229 so that the clamping unit 24 is fixed to the seat 22.

Referring to FIG. 4, to install the mounting device 2 of the present invention on the lug 14 of the drum 1, the clamping unit 24 is first positioned on the drum 1 by disposing the first clamp member 241 around the lug 14 so that the lug 14 is disposed within the first clamp member 241. Next, the rotatable knob 246 is rotated in a first direction so as to move the shaft 242, as well as the second clamp member 243, toward the second sidewall 248 until the lug 14 is clamped between the second clamp member 243 and the shock-absorbing member 244.

After the clamping unit 24 is positioned on the lug 14 of the drum 1, the locking unit 25, the C-shaped friction ring 23, and the seat 22 are sleeved in this sequence one after the other on the rod 211. This is performed prior to engagement of the seat 22 with the clamping unit 24 so as to enable mounting of the seat 22 on the rod 211 at a selected position. Next, the end 231 of the friction ring 23 is pushed into the annular space 224 so as to overlap the top split parts 221. Thereafter, the tubular member 251 is moved toward and embraces the friction ring 23 and the top split parts 221, and the internal screw thread 253 of the tubular member 251 is engaged with the external screw thread 225 of the top split parts 221. At this time, the friction ring 23 is disposed between the top split parts 221 and the tubular member 251. Accordingly, the inner surfaces 2211 of the top split parts 221 abut tightly against the rod 211, and the sleeve body 220 is locked against the rod 211.

Finally, the assembly of the holder 21 and the seat 22 is brought close to the clamping unit 24 so as to insert fittingly the intermediate wall 247 of the first clamp member 241 into the receiving space 230, after which the first screw 26 is used to fasten the intermediate wall 247 to the tab 229. At this time, the radial portion 2291 of the L-shaped tab 229 is received in the notched edge portion 2471 of the intermediate wall 247. The microphone support 212 is then fastened threadedly to the rod 211 opposite to the clamping unit 24. The microphone 3 is subsequently mounted on the microphone support 212, and some adjustments can be made so as to suitably position the microphone 3 relative to the drum 1.

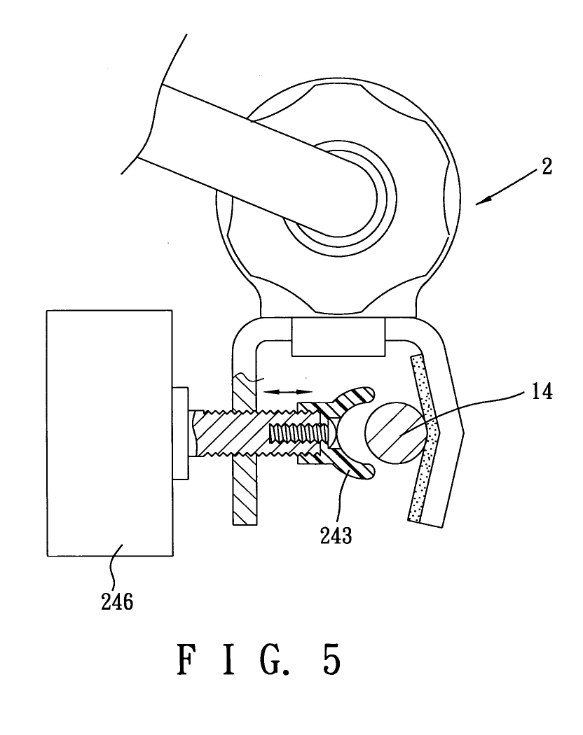

Referring to FIG. 5, the rotatable knob 246 is rotated in a second direction opposite to the first direction so as to separate the second clamp member 243 from the lug 14, thereby facilitating removal of the mounting device 2 of the present invention from the lug 14 of the drum 1.

From the aforementioned description of the preferred embodiment, the advantages of the mounting device 2 of the present invention can be summarized as follows:
1. Through the insertion of the end 231 of the friction ring 23 into the annular space 224 to overlap the friction ring 23 with the top split parts 221, and through the engagement of the locking unit 25 with the friction ring 23 and the top split parts 221, the rod 211 can be positioned stably on the clamping unit 24, which in turn enables the stable positioning of the microphone 3 on top of the drum 1.
2. Through the configurations of the top and bottom split parts 221, 223 which provide a significant amount of expandability, smooth insertion of the rod 211 is made possible, and the sleeve body 220 can accommodate a wide range of diameters of the rod 211.
3. When the second clamp member 243 and the shock-absorbing member 244 cooperate to clamp the lug 14 of the drum 1 therebetween, the vibration produced by the drumming of the drum 1 is effectively absorbed by the shock-absorbing member 244, which is rubber, thereby preventing excessive movement of the microphone 3. The end result is that the microphone 3 operates more effectively.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A mounting device for clamping a microphone on a musical instrument having at least one lug, said mounting device comprising:
a holder adapted to hold the microphone, and including a rod and a microphone support mounted on one end of said rod;
a seat sleeved fixedly on said rod proximate to the other end of said rod and including a sleeve body, said sleeve body including a plurality of axially extending split parts formed around said rod, and an external screw thread formed on outer surfaces of said split parts;
a locking unit movably disposed around said rod, and including a tubular member which can be sleeved around said split parts and which has an internal screw thread engageable with said external screw thread to tighten said split parts against said rod, said sleeve body being movable along said rod and being lockable against movement upon engagement with said tubular member; and
a clamping unit adapted to be disposed around the lug of the drum and attached to said seat.

2. The mounting device as claimed in claim 1, wherein said clamping unit includes a substantially U-shaped first clamp member which has opposite first and second sidewalls and an intermediate wall interconnecting said sidewalls, said clamping unit further including a threaded shaft extending threadedly through said first sidewall and into said first clamp member, and a second clamp member connected to said shaft within said first clamp member and having a curved surface contoured to correspond to an outer surface of the lug of the drum, said curved surface of said second clamp member confronting said second sidewall, said intermediate wall being attached to said seat, said shaft extending in a direction transverse to a direction of said rod.

3. The mounting device as claimed in claim 2, wherein said seat further includes an annular flange integral with and extending radially and outwardly from said sleeve body, an attachment plate projecting axially from an edge of said flange, and a substantially L-shaped tab having a radial portion connected to said attachment plate, and an axial portion projecting from said radial portion to define a receiving space with said attachment plate, said intermediate wall being fitted in said receiving space, said intermediate wall having a notched edge portion that receives said radial portion.

4. The mounting device as claimed in claim 2, further comprising a shock-absorbing member attached to said second sidewall and confronting said second clamp member, said second clamp member being movable toward said shock-absorbing member when said shaft is rotated.

5. The mounting device as claimed in claim 3, further comprising a screw for fastening said intermediate wall to said tab.

6. The mounting device as claimed in claim 1, wherein said split parts have inner surfaces abutting against said rod, said inner surfaces of said split parts being recessed at ends of said split parts to form an annular space around said rod.

7. The mounting device as claimed in claim 6, further comprising a C-shaped friction ring sleeved around said rod, said C-shaped friction ring having one end extending into said annular space, said tubular member embracing said friction ring and said split parts when said internal and external screw threads are interengaged.

8. The mounting device as claimed in claim 1, wherein said locking unit further includes a hollow knob body extending around and integral with said tubular member.
